(19) United States
(12) Patent Application Publication
(10) Pub. No.: US 2006/0287618 A1
(43) Pub. Date: Dec. 21, 2006

(54) Prevention of repetitive motion injury

(76) Inventor: Fernando Miranda, San Francisco, CA (US)

Correspondence Address: Kevin Redmond, 6960 SW Gator Trail, Palm City, FL, 34990, US

(21) Appl. No.: 11/481,774

(22) Filed: Jul. 6, 2006

Related U.S. Application Data
(63) Continuation-in-part of application No. 10/347,637, filed on Jan. 21, 2003, now abandoned.

(51) Int. Cl. A61H 1/00

(52) U.S. Cl. 601/46; 601/1

(57) ABSTRACT

A method and device for preventing RMI (Repetitive Motion Injury). Studies in adult monkeys have shown that RMI is accompanied by remodeling of the primary somatosensory cortical areas of the brain. The results of this is degradation in the sensory feedback from the cerebral cortex which appears to block normal adjustments by the subject in position and frequency that would prevent RMI. A variable amplitude, variable frequency generator and mechanical transducer contained in a small package and housed in a bracelet is applied to the extremity of a subject to transmit varying frequency signals that prevent the degradation in sensory feedback and as a result also prevent the development of RMI.

### BACKGROUND

1. Field

The present invention relates to the prevention of the remodeling of primary somatosensory (SI) cortical area of the brain and more particularly to the prevention of repetitive motion injury (RMI), such as carpal tunnel syndrome.

2. Prior Art

Virtually all current medical treatment of RMI is based on the premise that RMI leads to peripheral biochemical micro trauma which exhibits itself as chronic inflamation and insufficient of the blood supply to the affected tissues. These symptoms abate when the extremity involved is allowed to rest or the motion is modified such as by angling the wrist differently. Returning to the activity that produced the RMI usually causes an almost immediate return of the symptoms.

Many inventions have been directed to therapy after repetitive motion injuries have already occured, but do nothing to prevent such injuries as does the present invention. Such inventions includes those by Lee in U.S. Pat. No. 6,461,316 and Davis U.S. Pat. No. 6,093,164. Lee describes a sleeve which applies vibrating motion to a limb which has already sustained repetitive trauma syndrome. Both inventions describe message therapy after incurring the injury, not before. Neither describes applying vibrating message to an extremity while that extremity is engaged in repetitive motion to prevent injury.

Lee describes inducing calm by way of message therapy, but such calm or alertness does not prevent the cerebral cortex from failing to send out warning signal to change position or terminate the repetitive motion before it becomes injurious. Unlike these prior art invention, the present invention does provides a means for preventing RMI while still performing repetitive motions which otherwise would result in RMI.

### BRIEF DESCRIPTION OF THE FIGURES

FIG. 1 is a diagram of a test arrangement for monkeys designed to produce RMI.

FIG. 2 is a block diagram of a device used in accordance with the present invention to prevent the onset of RMI due to repetitive motion of an extremity.

FIG. 3 is a drawing showing the application of the present invention to an extremity.

### SUMMARY

It is an object of the present invention to prevent RMI while an individual continues to engage in the type of repetitive motion that normally results in RMI.

It is an object of the present invention to provide a device which can be conveniently attached to the extremity of an individual and which will prevent RMI even though that extremity is subject to repetitive motion.

It is an object of the present invention to produce a device which provides signals which varies in both frequency and intensity to determine the optimum combination for preventing RMI in general as well as the optimum combination for particular individuals.

The present invention includes a method and a device used in this method for preventing Repetitive Motion Injury (RMI). Studies in adult monkeys have shown that RMI is accompanied by remodeling of the primary somatosensory cortical areas of the brain. The results of this is degradation in the sensory feedback from the cerebral cortex which appears to block normal adjustments by the subject in position and frequency that would prevent RMI. A variable amplitude, variable frequency generator and mechanical transducer, contained in a small package and housed in a bracelet is applied to the extremity of an individual to transmit a varying sensory signals that prevent the degradation in sensory feedback and, as a result, prevents the development of RMI in the individual.

The brain in the area which controls an extremity becomes desensitized due to repetitive motion of that extremity and fails to give signals that the extremity should be rested or placed in a slightly different position to prevent injury to that extremity. By transmitting an externally generated signal from an affected extremity of an individual, where the signal varies in frequency and/or intensity, the brain is prevented from becoming desensitized. It therefore continues to transmit the signals needed to prevent RMI which when heeded by the individual will in fact prevent RMI.

The present invention provides this varied signal, optimized in frequency and amplitude, to achieve this result.

### DETAILED DESCRIPTION OF THE INVENTION

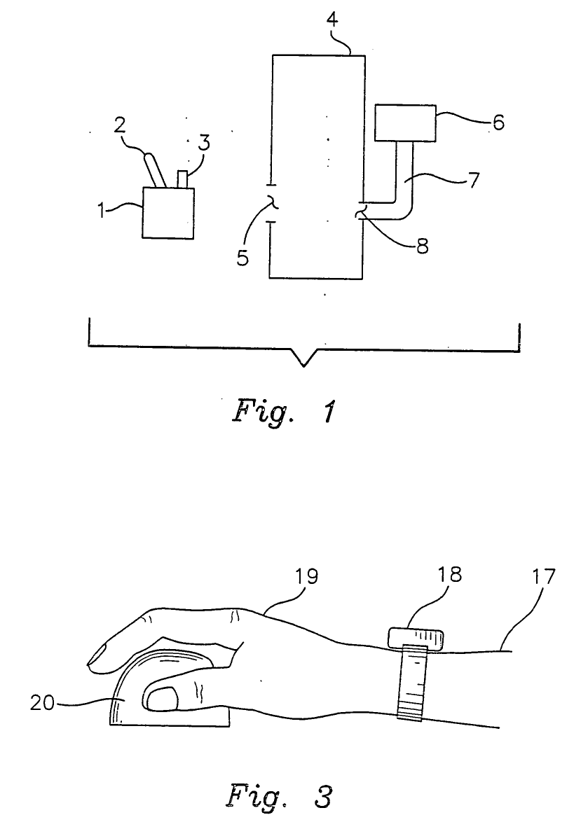

FIG. 1 illustrates the test arrangement used to examine the degradation in sensory feedback found in adult monkeys due to repetitive motion. This study was carried out at the University of California at the San Francisco School of Medicine and was reported on Aug. 30, 1995 in an article entitled “A Primate Genesis Model of Focal Dysonia and Repetitive Strain Injury”, published by the American Academy of Neurology.

FIG. 1 shows the principal elements used in the study which include a control box 1, a cage 4, with an attached pellet container 6. The control box 1 contains a handle 2, and a push button 3. The cage 4 contains a first opening 5 to permit a monkey within the cage to reach the control box. The cage also contains a second opening 8 which allows a monkey to receive pellets from one end of a tube 7 which is connected at its opposite end to the pellet container 6.

Two monkeys were tested separately in the arrangement shown in FIG. 1. A monkey within the cage was induced to reach out of the first opening and grasp a handle that rapidly opened and closed over short distances. The period of opening and closing was 20 ms. The training of the monkeys was continued until the performance accuracy which started at 80 to 90 percent dropped to only 50%.

An electrophysiologic mapping study of the representation of the hand within the primary somatosensory (SI) cortical zone was carried out. The area was degraded as indicated by a dedifferentiation of cortical representation that was 10 to 20 times larger than before the RMI activity and the degraded performance accuracy occurred.

This study indicated that there is a desensatizement of the area of the brain which controls the extremity subjected to RMI. Signal from the brain which would ordinarily indicated that rest or a change in position were required are not properly generated, resulting in continued use of the extremity along with resulting damage.

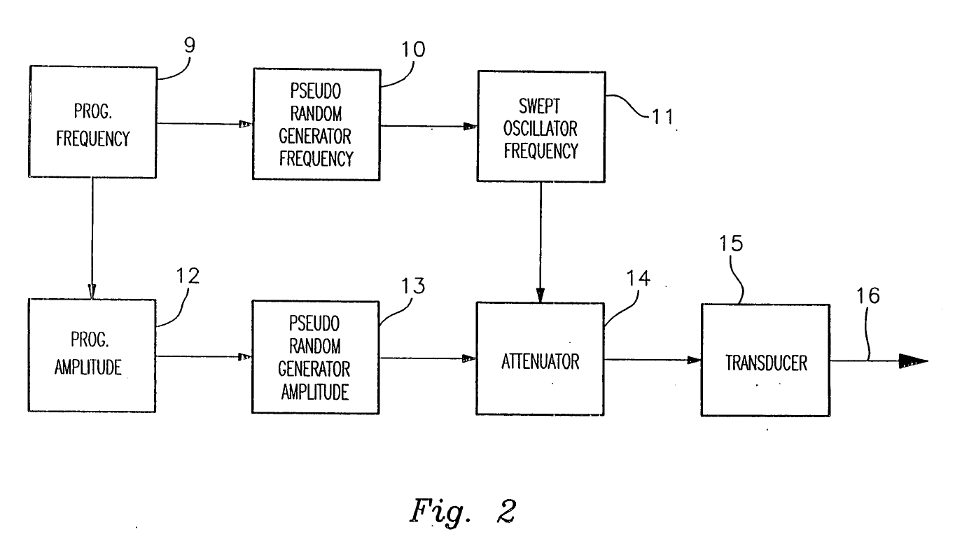

FIG. 2 is a block diagram of the device for generating an external signal that prevents the brain from becoming desensatized as described in the above study. This device includes a programmer for frequency 9, a pseudo random signal generator for frequency 10, a swept frequency oscillator 11, a programmer for amplitude 12, a pseudo random signal generator for amplitude 13, an attenuator 14 and a mechanical transducer 15 with an output port 16.

In the operation of this device, the programmer for frequency accepts manual or electrical inputs to produce frequenced programs output signals that correspond to the least degradation of the cortex due to repetitive motion for a particular individual. The inputs to the frequency programmer are typically set to cover a frequency range of 64 to 256 Hz. These output signals from the programmer are supplied to the pseudo random signal generator which produces an output that drives the swept frequency oscillator. The pseudo random signal generator produces signals that will set the swept frequency oscillator to pseudo random frequencies in the desired frequency range. The output of the swept frequency oscillator passes through the attenuator to the transducer which transmits the resulting signal out of port 16 to the extremity under consideration. Pseudo random generators produce a series of what appears to the brain to be a random frequency signals. In the pseudo random signal used in this invention, the pattern of frequencies should be such that a particular frequency signal will not appear more than once in nine signal bursts and preferably once in twenty four signal bursts. The period from one signal to the next should preferably not be less than a specific time, typically 20 MS.

It should be noted that pseudo random does not mean completely random. “Pseudo” means being apparent rather than actual. “Pseudo random” means being or involving entities (such as number or signals) that are selected for example by a definite computer aided process but, that satisfy one or more steps for randomness. What this means in practice is a signal that appears to be random but is actually generated by a computer aided system which does repeat, but does not do so for a specific period of time.

In a pseudo random signal, what appears to be random signal is actually a signal with a known pattern which is transmitted for a period and then the same pattern of what appears to be a random signal is then repeated. That is, a signal with the same frequency amplitude and time relationship to the start of the signal is repeated. That is the pattern of the pseudo random signal. This pattern is inherent in a pseudo random signal and is well known in the art.

As just noted, a pseudo random signal may appear to be random. The pseudo random signal typically starts out at one frequency and then changes to another, and then another and it may continue to change in what appears to be a random fashion. Actually, the changes in frequency are programmed and known and after a period of time of say 20 ms, the exact same set of signals, produced in the order that they were produced in the first 20 ms time period are repeated. Although during the first 20 ms time period they appear to be random, the repetition in the second 20 ms period means that they are not really random, hense the label “pseudo random”. As far as the brain is concerned they are random because when the second and subsequent 20 ms periods occur, the brain does not remember what was in the previous 20 ms period.

The signal to the transducer input may also be varied in intensity or amplitude by programming the programmer for amplitude to produce an output which is converted in the pseudo random signal generator for amplitude to a varying signal that controls the attenuator and thus the amplitude of the output signal. It is possible to vary the amplitude of a signal in many ways, such as by modulation, but any such means for producing a controlled variable amplitude signal is considered equivalent and within the spirit and scope of the invention.

It is possible to vary the amplitude and the frequency simultaneously to further optimize the output from port 16. The generator signal is transmitted through the transducer and delivered to the extremity of an individual, such as at the wrist where it is carried through the nervous system to the cortex. The variations in this externally generated signal prevents the brain from in effect ignoring the condition of the hand due to repetitive motion and thereby prevents RMI.

The variation in frequency may or may not be tied to the variation in amplitude. Varying both amplitude and frequency may be accomplished simply with available hardware. Typically, the input to the frequency varying system is either an analog voltage or a digital signal. For example, an input control voltage of zero volts might produce an output signal at the lowest frequency of the generator while an output control signal of 10 volts might produce an output signal at the maximum frequency of the generator. A similar control is common for an attenuation and 10 volts would produce minimum attenuation. Applying a single signal varying from zero to ten volts to both frequency control circuit and the attenuation control circuit would result in a signal varying amplitude that also varies with frequency. Once the frequency varying and attenuator circuit are available, it is an easy matter to connect voltage to both input to produce an output signal whose amplitude varies as a function of frequency.

The physical device usually used to provide a signal that is capable of varying in frequency is a variable frequency oscillator (VCO). The physical device for providing the drive signal to the VCO to produce a pseudo random variable frequency is a computer. The physical devices usually used to provide a signal that varies in amplitude is an electronically controlled attenuator or a variable gain amplifier. The physical device for providing the pseudo random signal is also a computer.

Although providing a means for varying the amplitude of signal and a means for varying signal in a pseudo random manner may seem to be similar, they are two different physical pieces of equipment.

It should be noted that either an analog or digital devices may be used in the programmers, pseudo random generators, swept frequency oscillator and attenuator. The system usually requires an analog signal in the output from the transducer which is normally a mechanical vibration transmitted by direct contact with the individuals extremity. An equivalent is to inject electrical signals directly into the individual.

FIG. 3 illustrates the application of the device shown in FIG. 2. This Figure shows a forearm 17, with the device of FIG. 2 contained in a bracelet 18 that is strapped to the wrist of the forearm. The hand 19 in this Figure is shown gripping a work piece 20.

The reason this device described above can prevent RMI can be understood by considering cases where repetitive motion of the extremities does not produce RMI. Concert pianists, who continually use their fingers, does not generally exhibit RMI, despite the constant and rapid movement of their fingers. One of the ways currently recommended to prevent carpal tunnel syndrome is to take breaks at regular intervals, stretch the fingers, alternate activities, change the of the concert pianists have in common is continuously varied activity of the extremity. This prevents the cortex from becoming degraded and provides the feedback signal which prompts varying, position grip and rapidity, all of which tends to prevent tissue damage.

The varied signal produced by the device of FIG. 2 can be transmitted from the extremities and delivering through the skin and bone structure to the cortex to prevent the degradation due to repetitive activity despite the presence of such activity. The externally generated signal reaches the cortex along with the repetitive motion signal, but the presents of the varied signal like that produced by the activity of the concert pianist prevents the degradation of the cortex and thus prevents RMI.

Having described my invention, I hereby claim:

1. A device for the prevention of repetitive motion injury occurring in an extremity of an individual, comprising:
(a) a signal generator for producing a variable frequency signal,
(b) a transducer for accepting said variable frequency signal and translating it into mechanical vibrations at the frequency of said variable frequency signal, and
(c) means for attaching said transducer to said extremity to transmit said variable frequency signal into said extremity to the nervous system of said individual for transmission through the nervous system of said individual to the portion of the brain of said individual which controls said extremity.

2. A device as claimed in claim 1 further comprising means for varying the amplitude of said signal.

3. A device as claimed in claim 1, wherein said device further includes means for programming the frequency of said variable frequency signal as a function of time.

4. A device as claimed in claim 3, wherein said device further includes means for programming the frequency of said variable frequency signal in a pseudo random manner.

5. A device as claimed in claim 4, wherein the pattern of the pseudo random signal does not reoccur for a fixed period.

6. A device as claimed in claim 5 wherein the pattern of the pseudo random signal does not reoccur for a minimum of 20 ms.

7. A device as claimed in claim 3 further includes means for programming said variable frequency signal in a completely random manner.

8. A device as claimed in claim 1, wherein the frequency is varied between fixed limits.

9. A device as claimed in claim 8 wherein the frequency is varied between 54 and 256 Hz.

10. A device as claimed in claim 3 further includes means for varying the amplitude of the signal.

11. A device as claimed in claim 10, wherein said device further includes means for programming the variation of the amplitude as a function of time.

12. A device as claimed in claim 10 in which the variation in amplitude is programmed to vary the signal in a pseudo random manner.

13. A device as claimed in claim 12 in which the same amplitude pattern does not reoccur for a minimum of a fixed period.

14. A device is claimed in claim 13 wherein said fixed period is a minimum of 20 ms.

15. A device as claimed in claim 11, wherein said programming of said amplitude includes means for varying the amplitude of said variable frequency signal as a function of the frequency of said variable frequency signal.

16. A method for the prevention of repetitive motion injury occurring in an extremity of an individual, comprising the steps of:
(a) providing a signal generator for producing a variable frequency signal,
(b) providing a transducer for accepting said variable frequency signal and translating it into mechanical vibrations at the frequency of said variable frequency signal, and
(c) providing means for attaching said transducer to said extremity to transmit said variable frequency signal into said extremity to the nervous system of said individual for transmission through the nervous system of said individual to the portion of the brain of said individual which controls said extremity.

17. A method as claimed in claim 16 further comprising the step of providing means for varying the amplitude of said signal.

18. A method as claimed in claim 16, wherein said method further includes the step of providing means for programming the frequency of said variable frequency signal as a function of time.

19. A method as claimed in claim 18, wherein said method further includes the step of providing means for programming the frequency of said variable frequency signal in a pseudo random manner.

20. A method as claimed in claim 19, wherein the pattern of the pseudo random signal does not reoccur for a minimum of 20 ms.

21. A method as claimed in claim 16 further includes the step of providing means for programming said variable frequency signal in a completely random manner.

22. A method as claimed in claim 16, wherein the frequency is varied between 64 Hz and 256 Hz.

23. A method as claimed in claim 18 further includes the step of providing means for varying the amplitude of the signal.

24. A method as claimed in claim 23, wherein said method further includes the step of providing means for programming the variation of the amplitude as a function of time.

25. A method as claimed in claim 23 in which the variation in amplitude is programmed to vary the signal in a pseudo random manner.

26. A method as claimed in claim 25 in which the same amplitude pattern does not reoccur for a minimum of a 20 ms.

27. A method as claimed in claim 23 wherein said step of programming of said amplitude includes providing means for varying the amplitude of said variable frequency signal as a function of the frequency of said variable frequency signal.
